(19) United States
(12) Patent Application Publication
(10) Pub. No.: US 2024/0154175 A1
(43) Pub. Date: May 9, 2024

(54) APPARATUS FOR MANUFACTURING SECONDARY BATTERY, METHOD FOR MANUFACTURING SECONDARY BATTERY, AND SECONDARY BATTERY

(71) Applicant: TOYOTA JIDOSHA KABUSHIKI KAISHA, Toyota-shi (JP)

(72) Inventors: Masashi CHIHARA, Nagoya-shi (JP); Norihiro OSE, Nagoya-shi (JP); Kenichi KAKISHITA, Nagoya-shi (JP); Sumiko KITO, Nagoya-shi (JP)

(73) Assignee: TOYOTA JIDOSHA KABUSHIKI KAISHA, Toyota-shi (JP)

(21) Appl. No.: 18/385,494

(22) Filed: Oct. 31, 2023

(30) Foreign Application Priority Data
Nov. 4, 2022 (JP) 2022-177658
Sep. 4, 2023 (JP) 2023-143077

(51) Int. Cl. H01M 10/058; H01M 10/0525; H01M 50/183; H01M 50/566

(52) U.S. Cl. CPC H01M 10/058; H01M 10/0525; H01M 50/183; H01M 50/566

(57) ABSTRACT

An apparatus for manufacturing a secondary battery includes: a conveying section that conveys a laminate-type secondary battery having a laminate outer package; plural contact rollers provided on a conveying path of the conveying section, the plural contact rollers having different contact angles with respect to an edge seal part of the laminate outer package being conveyed; and opposition rollers respectively disposed in opposition to the contact rollers, which, together with the contact rollers, fold the edge seal part of the laminate outer package.

### CROSS-REFERENCE TO RELATED APPLICATION

This application is based on and claims priority under 35 USC 119 from Japanese Patent Application No. 2022-177658 filed on Nov. 4, 2022, and Japanese Patent Application No. 2023-143077 filed on Sep. 4, 2023, the disclosures of which are incorporated by reference herein.

### BACKGROUND

### Technical Field

The present disclosure relates to an apparatus for manufacturing a secondary battery, a method for manufacturing a secondary battery, and a secondary battery.

### Related Art

A secondary battery in which an electrode body is covered with an outer package is known (see, for example, Japanese Patent Application Laid-open (JP-A) No. 2019-200973).

Japanese Patent Application Laid-Open No. 2019-200973 discloses a method of manufacturing a secondary battery having a folded portion at at least one end portion of an outer package subjected to lamination processing. This method of manufacturing the secondary battery includes: a step of bringing a holding plate into contact with a folding base point at the end of the outer package, and after the contacting step, a step of forming a folded part by sliding a holding plate and a pressing plate disposed at a position opposed to the holding plate so as to sandwich an end portion, and folding the end portion centered on the base point while sandwiching the end portion between the holding plate and the pressing plate.

In secondary batteries having an outer package, it is preferable to improve the volume density energy of the secondary battery. “Volume density energy” refers to the ratio of the volume of the electrode body contained in the secondary battery to the total volume of the secondary battery.

When an impact is applied to an electrode body contained in a secondary battery, the electrode body may be damaged and the properties of the secondary battery may become unable to be exhibited. Therefore, there is a need for secondary batteries having impact resistance.

### SUMMARY

The present disclosure provides an apparatus for manufacturing a secondary battery and a method for manufacturing a secondary battery that can produce a secondary battery having excellent volume density energy.

The present disclosure provides a secondary battery having excellent volume density energy and impact resistance.

An apparatus for manufacturing a secondary battery according to a first aspect of the present disclosure includes a conveying section that conveys a laminate-type secondary battery having a laminate outer package; plural contact rollers provided on a conveying path of the conveying section, the plural contact rollers having different contact angles with respect to an edge seal part of the laminate outer package being conveyed; and opposition rollers respectively disposed in opposition to the contact rollers, which, together with the contact rollers, fold the edge seal part of the laminate outer package.

In the present disclosure, a “laminate-type secondary battery” refers to a secondary battery provided with a laminate outer package. A “laminate outer package” refers to a case made of a laminate sheet. A “laminate sheet” refers to a sheet having at least a metal layer, a first resin layer layered on one main surface of the metal layer, and a second resin layer layered on the other main surface of the metal layer. An “edge seal part” refers to a part formed by welding together end parts of a laminate sheet in order to seal an electrode body.

According to the apparatus for manufacturing a secondary battery of the first aspect, by providing plural contact rollers having different contact angles with respect to the edge seal part of the laminate outer package being conveyed, the edge seal part of the laminate outer package is folded in stages. As a result, the spring-back amount of the edge seal part of the folded laminate outer package is suppressed. As a result, the volume density energy of the secondary battery can be improved. That is, the manufacturing apparatus of the first aspect can manufacture a secondary battery having excellent volume density energy.

In an apparatus for manufacturing a secondary battery according to a second aspect, a fold part is formed at at least one edge seal part of a laminate outer package of a laminate-type secondary battery. The manufacturing apparatus has a conveying section that conveys the secondary battery in one direction, and plural pairs of rollers that sandwich and the edge seal part. Each of the plural pairs of rollers has a contact roller, and an opposition roller disposed in opposition to the contact roller. The manufacturing apparatus passes the edge seal part of the secondary battery being conveyed by the conveying section between the plural pairs of rollers, folds the edge seal part in stages, and forms the fold part.

According to the apparatus for manufacturing a secondary battery of the second aspect, the spring-back amount of the fold part of the edge seal part is suppressed. As a result, the manufacturing apparatus of the second aspect can produce a secondary battery having excellent volume density energy.

An apparatus for manufacturing a secondary battery according to a third aspect of the present disclosure is the apparatus for manufacturing a secondary battery of the first aspect or second aspect, in which the contact roller provided at a downstream side in a conveying direction is a pressing roller, which is an elastic body and which presses the edge seal part of the laminate outer package from an outer side toward the opposition roller, which is disposed in a gap in a folded edge seal part of the laminate outer package.

According to the apparatus for manufacturing a secondary battery of the third aspect, in the apparatus for manufacturing a secondary battery of the first or second aspect, the contact roller provided at a downstream side in a conveying direction is a pressing roller that presses from an outer side toward the opposition roller disposed in a gap in the folded edge seal part of the laminate outer package, whereby the edge seal part of the laminate outer package is pressed so as to follow the outer shape of the opposition roller. As a result, the edge seal part of the laminate outer package can be configured in the intended folded posture.

An apparatus for manufacturing a secondary battery according to a fourth aspect of the present disclosure is the apparatus for manufacturing a secondary battery of any one of the first to third aspects, in which one of the contact roller or the opposition roller includes a restriction part that restricts movement of the laminate outer package in a direction orthogonal to a conveying direction.

According to the apparatus for manufacturing a secondary battery of the fourth aspect, one of the contact roller or the opposition roller includes a restriction part that restricts movement of the laminate outer package in a direction orthogonal to a conveying direction, whereby movement of the laminate outer package in a direction orthogonal to the conveying direction is restricted. Therefore, the edge seal part of the laminate outer package can be folded at the intended position.

An apparatus for manufacturing a secondary battery according to the fifth aspect of the present disclosure is the apparatus for manufacturing a secondary battery of any one of the first to fourth aspects, in which the edge seal part of the laminate outer package abuts against at least one of the contact roller or the opposition roller at a base part side of a base point portion for folding.

According to the apparatus for manufacturing a secondary battery according to the fifth aspect of the present disclosure, the edge seal part of the laminate outer package abuts against at least one of the contact roller or the opposition roller at a base part side of a base point portion for folding, whereby the occurrence of a difference in frictional force at the contact surface with the contact roller and the opposing roller is suppressed at the edge seal part of the laminate outer package. As a result, damage to the edge seal part of the laminate outer package can be suppressed.

An apparatus for manufacturing a secondary battery according to a sixth aspect of the present disclosure is the apparatus for manufacturing a secondary battery according to any one of the first to fifth aspects, in which the plural pairs of rollers fold the edge seal part in stages at least twice and form the fold part.

According to the apparatus for manufacturing a secondary battery according to the sixth aspect of the present disclosure, a secondary battery is obtained that has a fold part formed by folding an edge seal part at least two times. As a result, the manufacturing apparatus of the sixth aspect can produce a secondary battery with excellent volume density energy and impact resistance.

In a method for manufacturing a secondary battery according to a seventh aspect of the present disclosure, a laminate outer package of a secondary battery is conveyed between plural contact rollers having different contact angles with an edge seal part of the laminate outer package, and opposition rollers opposing the contact rollers; and the edge seal part of the laminate outer package is folded in stages.

According to the method for manufacturing a secondary battery of the seventh aspect, the laminate outer package of the secondary battery is conveyed between plural contact rollers having different contact angles with an edge seal part of the laminate outer package and opposition rollers opposing the contact rollers, and the edge seal part of the laminate outer package is folded in stages, whereby the spring-back amount of the edge seal part of the folded laminate outer package is suppressed. As a result, the volume density energy of the secondary battery can be improved. That is, the manufacturing method of the seventh aspect can produce a secondary battery having excellent volume density energy.

A secondary battery according to an eighth aspect of the present disclosure includes an electrode body; and a laminate outer package covering the electrode body and configured by a laminate sheet. The laminate outer package includes a housing part that houses the electrode body, and an edge seal part formed by welding together respective end parts of the laminate sheet. The edge seal part has a fold part formed by folding relative to a main surface of the electrode body. The fold part is formed by folding the edge seal part at least twice.

In the present disclosure, “folding the edge seal part at least twice” indicates that the edge seal part has at least two folding lines.

In the secondary battery according to the eighth aspect, the fold part is formed by folding the edge seal part two or more times. As a result, the impact resistance of the secondary battery according to the eighth aspect is superior to the conventional art. As a result, the secondary battery according to the eighth aspect has excellent volume density energy and impact resistance.

A secondary battery according to a ninth aspect of the present disclosure is the secondary battery of the eighth aspect, in which a first pressing load is 6.0 MPa or more. The fold part has an opposing surface facing a side surface of the housing part. The first pressing load indicates a load required for pressing a part of the fold part toward the side surface of the housing part and bringing the opposing surface into contact with the side surface of the housing part.

In the secondary battery according to the ninth aspect, the first pressing load is 6.0 MPa or more. The fact that the first pressing load is 6.0 MPa or more indicates that the rigidity of the fold part in the housing part is excellent. As a result, the secondary battery according to the ninth aspect has excellent impact resistance.

A secondary battery according to a tenth aspect of the present disclosure is the secondary battery of the eighth aspect or the ninth aspect, further including a terminal electrically connected to the electrode body. The laminate outer package further includes a terminal seal part enclosing and sealing the terminal, the terminal extending to an exterior of the laminate outer package. The fold part has an opposing surface that faces the housing part and a side surface of the terminal seal part. The terminal seal part has a convex welding part formed by welding an overlapping portion of the laminate sheet at the side surface of the terminal seal part. The convex welding part projects toward the opposing surface from the side surface of the terminal seal part.

In the secondary battery according to the tenth aspect, the terminal seal part has a convex welding part at the side surface. The convex welding part functions as a cushion material with respect to displacement of the fold part. As a result, the impact resistance of the secondary battery according to the tenth aspect is superior to a case in which the terminal seal part does not have a convex welded part. As a result, the secondary battery according to the tenth aspect has excellent volume density energy and impact resistance.

A secondary battery according to an eleventh aspect of the present disclosure is the secondary battery of the tenth aspect, in which a second pressing load is 12.0 MPa or more. The second pressing load indicates a load required for pressing an entirety of the fold part toward the side surface of the terminal seal part, crushing the convex welding part, and bringing the opposing surface into contact with the side surface of the terminal seal part. In the secondary battery according to the eleventh aspect of the present disclosure, the second pressing load is 12.0 MPa or more. The fact that the second pressing load is 12.0 MPa or more indicates that the rigidity of the fold part in the terminal seal part is excellent. As a result, the secondary battery according to the eleventh aspect has excellent impact resistance.

According to the present disclosure, it is possible to provide an apparatus for manufacturing a secondary battery and a method for manufacturing a secondary battery that can produce a secondary battery having excellent volume density energy.

According to the present disclosure, a secondary battery having excellent volume density energy and impact resistance can be provided.

### BRIEF DESCRIPTION OF THE DRAWINGS

Exemplary embodiments of the present disclosure will be described in detail based on the following figures, wherein:

FIG. 1 is a side view schematically illustrating an apparatus for manufacturing a secondary battery according to a first exemplary embodiment;

FIG. 2 is a cross-sectional view schematically illustrating a secondary battery according to the first exemplary embodiment, illustrating a cross-section taken along line A-A in FIG. 1;

FIG. 3 is a cross-sectional view schematically illustrating an upstream roller pair according to the first exemplary embodiment, illustrating a cross-section taken along line B-B in FIG. 1;

FIG. 4 is a cross-sectional view schematically illustrating an intermediate roller pair according to the first exemplary embodiment, illustrating a cross section taken along line C-C in FIG. 1;

FIG. 5 is a cross-sectional view schematically illustrating a furthest downstream roller pair according to the first exemplary embodiment, illustrating a cross-section taken along line D-D in FIG. 1;

FIG. 6 is a perspective view of the secondary battery according to the first embodiment;

FIG. 7 is a cross-sectional view taken along line VII-VII of FIG. 6;

FIG. 8 is a cross-sectional view taken along line VIII-VIII of FIG. 6;

FIG. 9 is a diagram for explaining a method of measuring a first pressing load;

FIG. 10 is a diagram for explaining a method of measuring a third pressing load;

FIG. 11 is a diagram for explaining a method of measuring a second pressing load;

FIG. 12 is a schematic cross-sectional view showing an example of a unit electrode body in the first embodiment of the present disclosure; and

FIG. 13 is a cross-sectional view schematically showing an upstream roller pair according to the second embodiment.

### DETAILED DESCRIPTION

Numerical ranges indicated using “from . . . to . . . ” in the present disclosure mean ranges in which the numerical values indicated in “from . . . to . . . ” are included as the minimum value and the maximum value, respectively. In numerical ranges described in the present disclosure in a stepwise manner, the upper limit value or the lower limit value described in a certain numerical range may be replaced with the upper limit value or the lower limit value of another numerical range described in a stepwise manner. In the present disclosure, a combination of two or more preferred embodiments is a more preferred embodiment. In the present disclosure, the term “step” is not only an independent step, but also includes a case in which the intended purpose of the step is achieved, even if it cannot be clearly distinguished from other steps.

Hereinafter, with reference to the drawings, embodiments of the apparatus for manufacturing the secondary battery, the method for manufacturing the secondary battery, and the secondary battery of the present disclosure are described. In the drawings, the same or corresponding parts are denoted by the same reference numerals, and description thereof is not repeated.

### (1) First Embodiment

In the following, an apparatus for producing a secondary battery according to a first embodiment is described with reference to the drawings. In the first embodiment, an apparatus 10 for manufacturing a laminate-type secondary battery 20 is described as an apparatus for folding an edge seal part 28 (hereinafter, also referred to as an “edge part 28”) of a laminate outer package 22 (hereinafter, also referred to as an “outer package 22”) of a secondary battery 20.

(1.1) Configuration of Secondary Battery 20

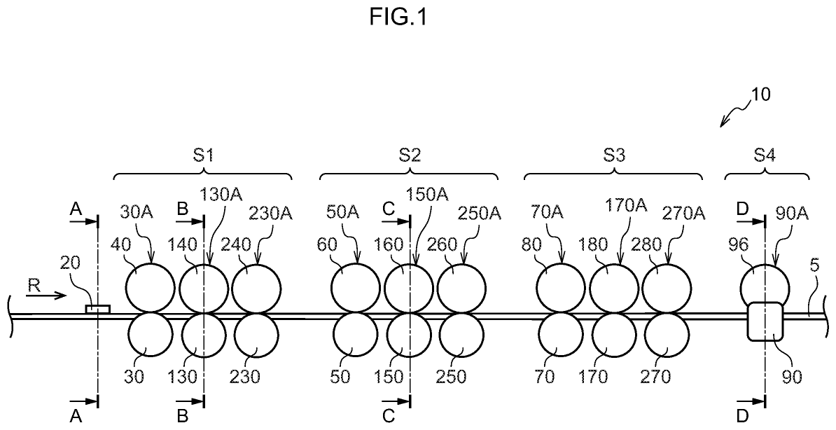

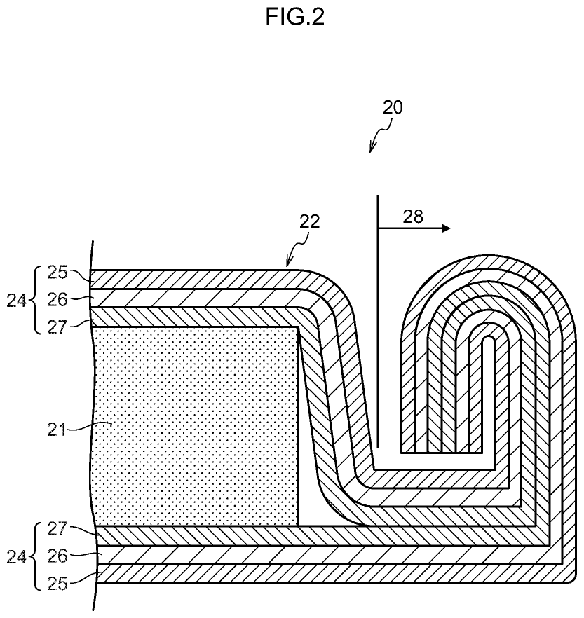

As shown in FIGS. 1 and 2, a laminate-type secondary battery 20 includes an electrode body 21 and an outer package 22 which covers the electrode body 21. The outer package 22 is configured by two laminate sheets 24. The laminate sheet 24 is configured as a layered body in which an outer insulating layer 25, a metal layer 26, and an inner insulating layer 27 are layered. The two laminate sheets 24 have the electrode body 21 interposed therebetween, and the inner insulating layers 27 are connected to each other at the peripheral edges thereof, whereby the edge part 28 of the outer package 22 is formed. The edge part 28 is formed by folding an end part by approximately 180° and further folding by approximately 90°. Details of the secondary battery 20 are described below.

(1.2) Configuration of Apparatus 10 for Manufacturing Secondary Battery 20

The apparatus 10 for manufacturing the secondary battery 20 includes a conveying section 5, an upstream roller group S1, an intermediate roller group S2, a downstream roller group S3, and a furthest downstream roller group S4. The upstream roller group S1, the intermediate roller group S2, the downstream roller group S3, and the furthest downstream roller group S4 are an example of plural pairs of rollers.

(1.2.1) Conveying Section 5

As shown in FIG. 1, the conveying section 5 is configured to convey the secondary battery 20 in the conveying direction (rightward in FIG. 1) R.

(1.2.2) Upstream Roller Group S1

The upstream roller group S1 is provided on one side of a conveying path in the width direction along the conveying path of the conveying section 5. The upstream roller group S1 is disposed upstream of the intermediate roller group S2 in the conveying direction R. The upstream roller group S1 includes a first upstream roller pair 30A, a second upstream roller pair 130A, and a third upstream roller pair 230A.

The first upstream side roller pair 30A includes a first upstream contact roller 30 and a first upstream opposition roller 40 disposed in opposition to the first upstream contact roller 30. The second upstream side roller pair 130A includes a second upstream contact roller 130 and a second upstream opposition roller 140 disposed in opposition to the second upstream contact roller 130. The third upstream side roller pair 230A includes a third upstream contact roller 230 and a third upstream opposition roller 240 disposed in opposition to the third upstream side contact roller 230.

The first upstream roller pair 30A, the second upstream roller pair 130A, and the third upstream roller pair 230A are configured similarly, with the exception that the inclination angles of the contact surfaces that abut against the edge part 28 of the outer package 22 are different. Hereinafter, explanation follows mainly regarding the second upstream roller pair 130A.

(1.2.2.1) Second Upstream Roller Pair 130A

(1.2.2.1.1) Second Upstream Contact Roller 130

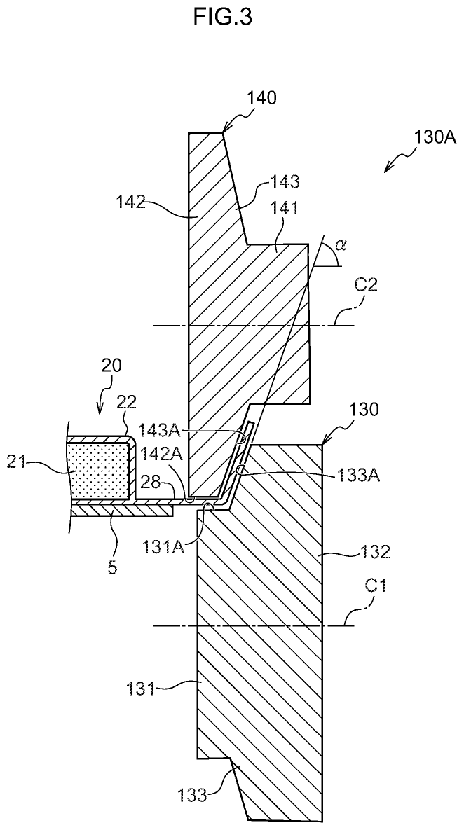

As illustrated in FIG. 3, the second upstream contact roller 130 is configured to be rotatable relative to a horizontal rotation axis C1 orthogonal to the conveying direction R. The second upstream contact roller 130 is formed of, for example, metal, resin, or the like, and includes a small diameter section 131, a large diameter section 132, and an intermediate section 133.

The small diameter section 131 is disposed on the side of the large diameter section 132 that is closer to the conveying section 5. The large diameter section 132 has a larger outer diameter than the small diameter section 131. The intermediate section 133 is disposed between the large diameter section 132 and the small diameter section 131. The intermediate section 133 is formed in a truncated conical shape that expands in diameter from the small diameter section 131 toward the large diameter section 132 so as to connect the outer shape of the large diameter section 132 and the outer shape of the small diameter section 131 together. The outer peripheral surface 133A of the intermediate section 133 is an inclined surface inclined at an angle α (e.g., 60°) relative to the horizontal direction. The outer peripheral surface 133A of the intermediate section 133 and the outer peripheral surface 131A of the small diameter section 131 are contact surfaces that abut against the edge part 28 of the outer package 22 conveyed by the conveying section 5.

(1.2.2.1.2) Second Upstream Opposition Roller 140

The second upstream opposition roller 140 is configured to be rotatable relative to a horizontal rotation axis C2 orthogonal to the conveying direction R. The second upstream opposition roller 140 is disposed above the second upstream contact roller 130 so as to face the second upstream contact roller 130. The second upstream opposition roller 140 is formed of, for example, metal, resin, or the like, and includes a small diameter section 141, a large diameter section 142, and an intermediate section 143.

The large diameter section 142 is disposed on the side of the small diameter section 141 that is closer to the conveying section 5. The large diameter section 142 has a larger outer diameter than the small diameter section 141. The intermediate section 143 is disposed between the large diameter section 142 and the small diameter section 141. The intermediate section 143 is formed in a truncated conical shape that expands in diameter from the small diameter section 141 toward the large diameter section 142 so as to connect the outer shape of the large diameter section 142 and the outer shape of the small diameter section 141 together. The outer peripheral surface 143A of the intermediate section 143 is an inclined surface inclined at an angle α (e.g., 60°) relative to the horizontal direction. The outer peripheral surface 143A of the intermediate section 143 and the outer peripheral surface 142A of the large-diameter section 142 are contact surfaces that abut against the edge part 28 of the outer package 22 conveyed by the conveying section 5.

The second upstream contact roller 130 and the second upstream opposition roller 140 are configured to fold the edge part 28 of the outer package 22 conveyed by the conveying section 5 at an angle α (e.g., 60°).

(1.2.2.2) First Upstream Roller Pair 30A

In the first upstream roller pair 30A, the outer peripheral surface of the intermediate section of the first upstream contact roller 30 is an inclined surface inclined at an angle α (e.g., 30°) relative to the horizontal direction. An outer peripheral surface of an intermediate portion of the first upstream opposition roller 40 is an inclined surface inclined at an angle α (e.g., 30°) relative to a horizontal direction. The first upstream contact roller 30 and the first upstream opposition roller 40 are configured to fold the edge part 28 of the outer package 22 conveyed by the conveying section 5 at an angle α (e.g., 30°).

(1.2.2.3) Third Upstream Roller Pair 230A

In the third upstream roller pair 230A, the outer peripheral surface of the intermediate section of the third upstream contact roller 230 is an inclined surface inclined at an angle α (e.g., 90°) relative to the horizontal direction. An outer peripheral surface of an intermediate portion of the third upstream opposition roller 240 is an inclined surface inclined at an angle α (e.g., 90°) relative to a horizontal direction. The third upstream contact roller 230 and the third upstream opposition roller 240 are configured to fold the edge part 28 of the outer package 22 conveyed by the conveying section 5 at an angle α (e.g., 90°).

In other words, in the first upstream roller pair 30A, the second upstream roller pair 130A, and the third upstream roller pair 230A, the contact angles of the contact surfaces that abut the edge parts 28 of the outer package 22 being conveyed are different.

(1.2.3) Intermediate Roller Group S2

As illustrated in FIG. 1, the intermediate roller group S2 is provided on one side of the conveying path in the width direction along the conveying path of the conveying section 5. The intermediate roller group S2 is disposed downstream of the upstream roller group S1 in the conveying direction R. The intermediate roller group S2 includes a first intermediate roller pair 50A, a second intermediate roller pair 150A, and a third intermediate roller pair 250A.

The first intermediate roller pair 50A includes a first intermediate contact roller 50 serving as a contact roller, and a first intermediate opposition roller 60 serving as an opposition roller disposed opposing the first intermediate contact roller 50. The second intermediate roller pair 150A includes a second intermediate contact roller 150 serving as a contact roller, and a second intermediate opposition roller 160 serving as an opposition roller disposed opposing the second intermediate contact roller 150. The third intermediate roller pair 250A includes a third intermediate contact roller 250 serving as a contact roller, and a third intermediate opposition roller 260 serving as an opposition roller disposed opposing the third intermediate contact roller 250.

The first intermediate roller pair 50A, the second intermediate roller pair 150A, and the third intermediate roller pair 250A are configured similarly, with the exception that the inclination angles of the contact surfaces that abut against the edge part 28 of the outer package 22 are different. Hereinafter, explanation follows mainly regarding the second intermediate roller pair 150A.

(1.2.3.1) Second Intermediate Roller Pair 150A

(1.2.3.1.1) Second Intermediate Contact Roller 150

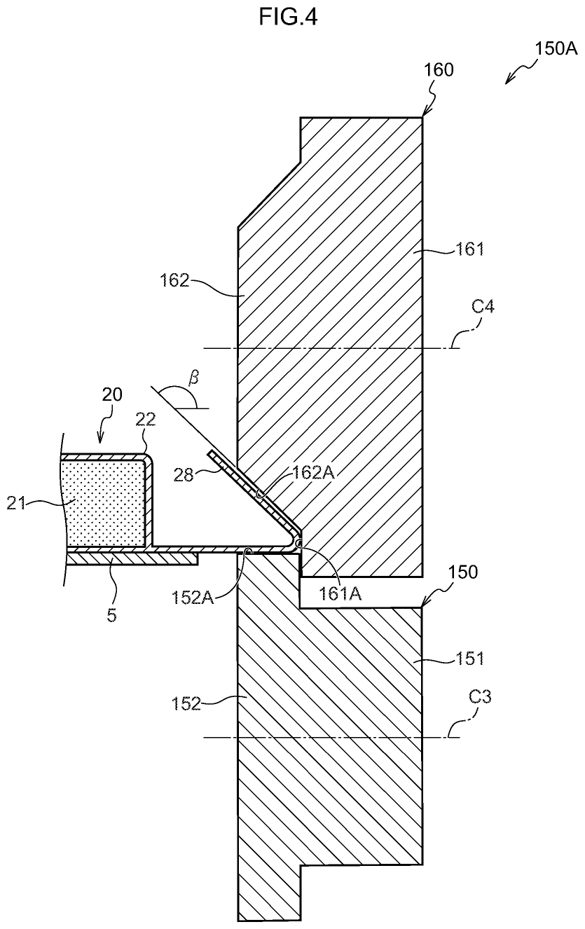

As illustrated in FIG. 4, the second intermediate contact roller 150 is configured to be rotatable relative to a horizontal rotation axis C3 orthogonal to the conveying direction R. The second intermediate contact roller 150 is, for example, a stepped roller formed of metal, resin, or the like, and includes a small diameter section 151 and a large diameter section 152.

The large diameter section 152 is disposed on a side of the small diameter section 151 closer to the conveying section 5. The large diameter section 152 has a larger outer diameter than the small diameter section 151. The outer peripheral surface 152A of the large diameter section 152 is a contact surface that abuts against the edge part 28 of the outer package 22 conveyed by the conveying section 5.

Second Intermediate Opposition roller 160

The second intermediate opposition roller 160 is configured to be rotatable relative to a horizontal rotation axis C4 orthogonal to the conveying direction R. The second intermediate opposition roller 160 is disposed above the second intermediate contact roller 150 in opposition to the second intermediate contact roller 150. The second intermediate opposition roller 160 is, for example, a stepped roller formed of metal, resin, or the like, and includes a large diameter section 161 and a small diameter section 162.

The small diameter section 162 is disposed on the conveying section 5 side of the large diameter section 161. The large diameter section 161 has a larger outer diameter than the small diameter section 162. The small diameter section 162 is formed in a truncated conical shape that expands in diameter toward the large diameter section 161. The outer peripheral surface 162A of the small diameter section 162 is an inclined surface inclined at an angle R (e.g., 150°) relative to the horizontal direction. The outer peripheral surface 162A of the small diameter section 162 and the end surface 161A of the large diameter section 161 on the side of the conveying section 5 are contact surfaces that abut against the edge part 28 of the outer package 22 conveyed by the conveying section 5. The end surface 161A of the large diameter section 161 configures a restriction part that restricts movement of the outer package 22 in a direction orthogonal to the conveying direction R.

The second intermediate contact roller 150 and the second intermediate opposition roller 160 are configured to fold the edge part 28 of the outer package 22 conveyed by the conveyance section 5 at an angle β (for example, 150°).

(1.2.3.2) First Intermediate Roller Pair 50A

In the first intermediate roller pair 50A, the outer peripheral surface of the small diameter section of the first intermediate opposition roller 60 is an inclined surface inclined at an angle β (e.g., 120°) relative to the horizontal direction. The first intermediate contact roller 50 and the first intermediate opposition roller 60 are configured to fold the edge part 28 of the outer package 22 conveyed by the conveying section 5 at an angle β (e.g., 120°).

(1.2.3.3) Third Intermediate Roller pair 250A

In the third intermediate roller pair 250A, the outer peripheral surface of the small diameter section of the third intermediate opposition roller 260 is an inclined surface inclined at an angle β (e.g., 180°) relative to the horizontal direction. The third intermediate contacting roller 250 and the third intermediate opposition roller 260 are configured to fold the edge part 28 of the outer package 22 conveyed by the conveying section 5 at an angle β (e.g., 180°). Namely, the first intermediate roller pair 50A, the second intermediate roller pair 150A, and the third intermediate roller pair 250A have different contact angles of the contact surfaces that abut against the edge part 28 of the conveyed outer package 22.

(1.2.4) Downstream Roller Group S3

As illustrated in FIG. 1, the downstream roller group S3 has a configuration similar to the upstream roller group S1, and is provided on one side of the conveying path in the width direction along the conveying path of the conveying section 5. The downstream roller group S3 is disposed downstream of the intermediate roller group S2 in the conveying direction R.

The downstream roller group S3 includes a first downstream roller pair 70A, a second downstream roller pair 170A, and a third downstream roller pair 270A.

The first downstream roller pair 70A includes a first downstream contact roller 70 serving as a contact roller, and a first downstream opposition roller 80 serving as an opposition roller disposed in opposition to the first downstream contact roller 70. The second downstream roller pair 170A includes a second downstream contact roller 170 serving as a contact roller, and a second downstream opposition roller 180 serving as an opposition roller disposed in opposition to the second downstream contact roller 170. The third downstream roller pair 270A includes a third downstream contact roller 270 serving as a contact roller, and a third downstream opposition roller 280 serving as an opposition roller disposed in opposition to the third downstream contact roller 270.

The first downstream roller pair 70A, the second downstream roller pair 170A, and the third downstream roller pair 270A are configured similarly, with the exception that the inclination angles of the contact surfaces that abut against the edge part 28 of the outer package 22 are different.

(1.2.4.1) First Downstream Roller Pair 70A

In the first downstream roller pair 70A, the outer peripheral surface of the intermediate section of the first downstream contact roller 70 is an inclined surface inclined at an angle α (e.g., 30°) relative to the horizontal direction. An outer peripheral surface of an intermediate section of the first downstream opposition roller 80 is an inclined surface inclined at an angle α (e.g., 30°) relative to a horizontal direction. The first downstream contact roller 70 and the first downstream opposition roller 80 are configured to fold the edge part 28 of the outer package 22 conveyed by the conveying section 5 at an angle α (e.g., 30°).

(1.2.4.2) Second Downstream Roller Pair 170A

In the second downstream roller pair 170A, the outer peripheral surface of the intermediate section of the second downstream contact roller 170 is an inclined surface inclined at an angle α (e.g., 60°) relative to the horizontal direction. An outer peripheral surface of an intermediate section of the second downstream opposition roller 180 is an inclined surface inclined at an angle α (e.g., 60°) relative to a horizontal direction. The second downstream contact roller 170 and the second downstream opposition roller 180 are configured to fold the edge part 28 of the outer package 22 conveyed by the conveying section 5 at an angle α (e.g., 60°).

(1.2.4.3) Third Downstream Roller Pair 270A

In the third downstream roller pair 270A, the outer peripheral surface of the intermediate section of the third downstream contact roller 270 is an inclined surface inclined at an angle α (e.g., 90°) relative to the horizontal direction. An outer peripheral surface of an intermediate portion of the third downstream opposition roller 280 is an inclined surface inclined at an angle α (e.g., 90°) relative to a horizontal direction. The third downstream contact roller 270 and the third downstream opposition roller 280 are configured to fold the edge part 28 of the outer package 22 conveyed by the conveying section 5 at an angle α (e.g., 90°). Namely, the first downstream roller pair 70A, the second downstream roller pair 170A, and the third downstream roller pair 270A have different contact angles of the contact surfaces that abut against the edge part 28 of the conveyed outer package 22.

(1.2.5) Furthest Downstream Roller Group S4

As shown in FIG. 1, the furthest downstream roller group S4 is provided on one side of the conveying path in the width direction along the conveying path of the conveyance section 5. The furthest downstream roller group S4 is disposed downstream of the downstream roller group S3 in the conveying direction R. The furthest downstream roller group S4 includes a furthest downstream roller pair 90A. The furthest downstream roller pair 90A includes a furthest downstream contact roller 90 serving as a contact roller, and a furthest downstream opposition roller 96 serving as an opposition roller.

(1.2.5.1) Furthest Downstream Contact Roller 90

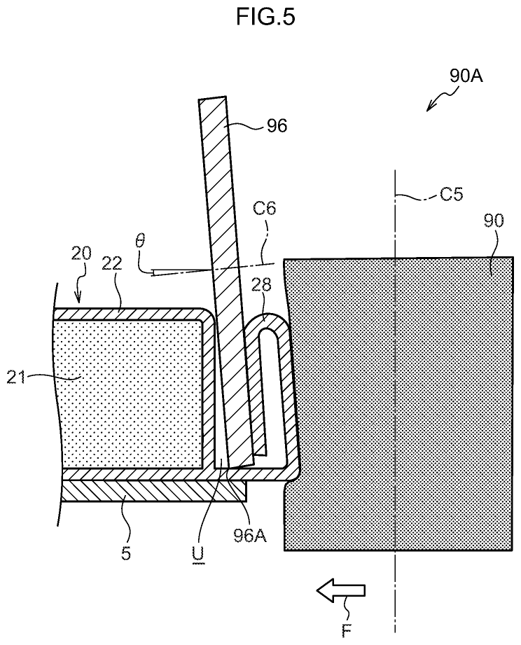

As illustrated in FIG. 5, the furthest downstream contact roller 90 is configured to be rotatable relative to a vertical rotation axis C5 orthogonal to the conveying direction R. The furthest downstream contact roller 90 is formed of an elastic material at least on its surface layer. The furthest downstream contact roller 90 is biased by a spring or the like in a direction F approaching the conveying section 5 in a width direction of the conveying section 5. The furthest downstream contact roller 90 presses the edge part 28 of the outer package 22 conveyed by the conveying section 5 from the outside toward the furthest downstream opposition roller 96.

(1.2.5.2) Furthest Downstream Opposition Roller 96

The furthest downstream opposition roller 96 is formed of, for example, metal, resin, or the like. The furthest downstream opposition roller 96 is disposed at a side of the furthest downstream contact roller 90 so as to be opposed to the furthest downstream contact roller 90. The furthest downstream opposition roller 96 is disposed with a lower end inserted into a gap U of the folded edge part 28 of the outer package 22. The furthest downstream opposition roller 96 is configured to be rotatable relative to a rotation axis C6 that is inclined at a predetermined angle β relative to a horizontal direction orthogonal to the conveying direction R. The furthest downstream opposition roller 96 is disposed so that a corner 96A at a lower end of the furthest downstream opposition roller 96 abuts against the edge part 28. As a result, the edge part 28 of the outer package 22 conveyed by the conveying section 5 is folded at a position where the corner section 96A is in contact with the edge part 28, serving as a base point for folding. Namely, the corner 96A of the furthest downstream opposition roller 96 contacts the edge part 28 of the outer package 22 at the base point for folding the edge part 28 of the outer package 22.

(1.3) Method of Manufacturing Secondary Battery 20

As illustrated in FIG. 1, a secondary battery 20 in which the edge part 28 of the outer package 22 is not folded is placed on the conveying section 5.

Next, the conveying section 5 conveys the secondary battery 20 in the conveying direction R. Next, as illustrated in FIG. 3, the edge part 28 of the outer package 22 is folded at 30° by the first upstream roller pair 30A, folded at 60° by the second upstream roller pair 130A, and folded at 90° by the third upstream roller pair 230A. Namely, the outer package 22 of the secondary battery 20 is conveyed to the first upstream roller pair 30A, the second upstream roller pair 130A, and the third upstream roller pair 230A, which abut against the edge part 28 of the outer package 22 at different contact angles, and the edge part 28 of the outer package 22 is folded in stages.

Next, as illustrated in FIG. 4, the edge part 28 of the outer package 22 is folded at 120° by the first intermediate roller pair 50A, is folded at 150° by the second intermediate roller pair 150A, and is folded at 180° by the third intermediate roller pair 250A. At this time, the end surface of the large diameter section of each opposition roller (in the second intermediate roller pair 150A, the end surface 161A of the large diameter section 161 of the second intermediate opposition roller 160) restricts movement of the outer package 22 in a direction orthogonal to the conveying direction R.

Next, the edge part 28 of the outer package 22 folded at 180° is folded at 30° by the first downstream roller pair 70A, is folded at 60° by the second downstream roller pair 170A, and is folded at 90° by the third downstream roller pair 270A.

Next, as illustrated in FIG. 5, the edge part 28 of the outer package 22 that has been folded at 180° and further folded at 90° is pressed from the outside toward the furthest downstream opposition roller 96 by the furthest downstream contact roller 90. Through the above steps, the edge part 28 of the outer package 22 of the secondary battery 20 is folded as illustrated in FIG. 2.

(1.4) Secondary Battery

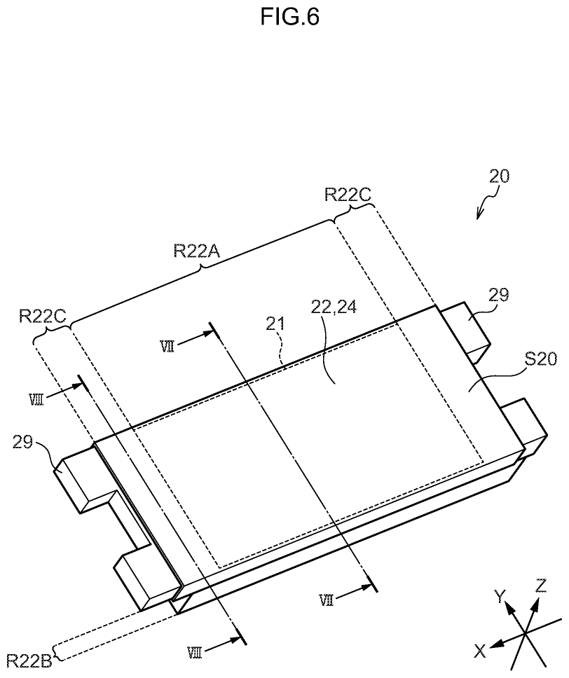

As shown in FIG. 6, the secondary battery 20 includes an electrode body 21, an outer package 22, and a pair of terminals 29. One of the pair of terminals 29 is a positive electrode terminal. The other of the pair of terminals 29 is a negative electrode terminal. The electrode body 21 is a rectangular parallelepiped.

In the first embodiment, one side of the main surface of the electrode body 21 in the longitudinal direction is defined as the X-axis positive direction, and the opposite side thereof is defined as the X-axis negative direction. One side of the main surface of the electrode body 21 in the transverse direction is defined as the Y-axis positive direction, and the opposite side thereof is defined as the Y-axis negative direction. One side of the electrode body 21 in the thickness direction is defined as the Z-axis positive direction, and the opposite side thereof is defined as the Z-axis negative direction. The X-axis, the Y-axis, and the Z-axis are respectively orthogonal to each other. Note that these orientations do not limit the orientation of the secondary battery of the present disclosure when used.

The pair of terminals 29 is arranged in mutual opposition across the electrode body 21. Specifically, the pair of terminals 29 is arranged so as to sandwich the electrode body 21 in the X-axis direction. Each of the pair of terminals 29 is electrically connected to the electrode body 21. The outer package 22 covers the electrode body 21. The electrode body 21 is sealed by the pair of terminals 29 and the outer package 22.

In the first embodiment, the secondary battery 20 is a laminate-type lithium secondary battery using a solid electrolyte. Examples of the use of the secondary battery 20 include an in-vehicle power supply, a power supply for an information processing device (for example, a personal computer, a smartphone, or the like), and a power supply for power storage.

(1.4.1) Terminal

The terminal 29 is a rectangular parallelepiped. The shape of the terminal 29 as viewed in the Z-axis direction is U-shaped. The longitudinal direction of the terminal 29 is defined as the Y-axis direction, and the transverse direction is defined as the X-axis direction. Examples of the material of the terminal 29 include a metal (for example, stainless steel (SUS)).

(1.4.2) Laminate Outer Package

The outer package 22 covers the electrode body 21 and seals the electrode body 21 together with the pair of terminals 29. The outer package 22 is configured by two laminate sheets 24. The two laminate sheets 24 are folded to function as the outer package 22.

As shown in FIG. 6, the outer package 22 has a housing part R22A, an edge part 28 (hereinafter, also referred to as “edge seal part R22B”), and a pair of terminal seal parts R22C. The housing part R22A is positioned at the center part of the secondary battery 20 in the X-axis direction. The edge seal part R22B is positioned at an edge part of the secondary battery 20 in the Y-axis negative direction. The pair of terminal seal parts R22C are arranged so as to sandwich the housing part R22A in the X-axis direction.

(1.4.2.1) Housing Part

The housing part R22A houses the electrode body 21. The shape of the housing part R22A follows the shape of the electrode body 21.

(1.4.2.2) Edge Seal Part

The edge seal part R22B is formed by welding together the end parts of the laminate sheet 24. The edge seal part R22B is a part that is thermocompression-bonded by a heating instrument (for example, a heat bar).

The edge seal part R22B has a fold part R22B0. The fold part R22B0 is folded with respect to the main surface S20 (XY surface) of the electrode body 21.

In the first embodiment, the fold part R22B0 is formed by folding the edge seal part R22B twice. In other words, the edge seal part R22B has three fold lines FL. Specifically, the fold part R22B0 has a first fold part R22B1, a second fold part R22B2, and a third fold part R22B3. The first fold part R22B1, the second fold part R22B2, and the third fold part R22B3 are formed in this order. Each of the first fold part R22B1, the second fold part R22B2, and the third fold part R22B3 is flat-plate-shaped. The folding angle of the first fold part R22B1 with respect to the main surface S20 of the electrode body 21 is 90° C. The folding angle of the second fold part R22B2 with respect to the main surface S20 of the electrode body 21 is 180° C. The folding angle of the third fold part R22B3 with respect to the main surface S20 of the electrode body 21 is 270° C.

The fold part R22B0 has an opposing surface SR22B which faces a side surface SR22A of the housing part R22A and a first side surface SR22CA of the terminal seal part R22C. In the first embodiment, the opposing surface SR22B is configured by the third fold part R22B3.

(1.4.2.3) Terminal Seal Part

The terminal seal part R22C effects sealing by enclosing the terminal 29 extending toward the exterior of the outer package 22. The terminal seal part R22C is welded to the terminal 29. The shape of the terminal seal part R22C follows the shape of the terminal 29.

Each of the pair of terminal seal parts R22C has three convex welding parts R22C0. One of the convex welding parts R22C0 is formed on the Z-axis positive direction edge of the first side surface SR22CA of the terminal seal part R22C. Two of the convex welding parts R22C0 are formed on respective edges in the Z-axis positive direction of a second side surface SR22CB of the terminal seal part R22C. The convex welding part R22C0 is formed by welding an overlapping part of the laminate sheet 24. The convex welding part R22C0 is a part that is thermocompression-bonded by a heating instrument (for example, a heat bar). The convex welded part R22C0 extends along the X-axis direction.

The terminal seal part R22C may be welded to the terminal 29 via a known resin member (for example, a tab film).

(1.4.2.4) Rigidity of Fold Part of Housing Part (Edge Part Pressing)

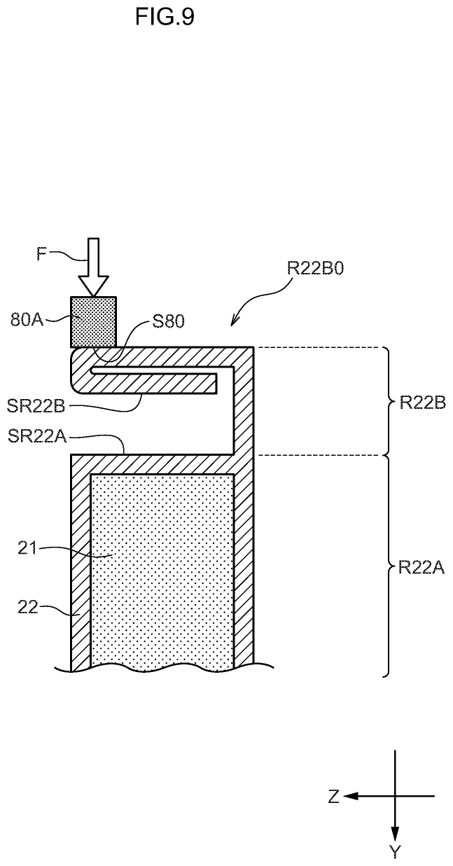

In the first embodiment, a first pressing load is 6.0 MPa or more. As shown in FIG. 9, the first pressing load indicates a load required to press a part of the fold part R22B0 toward the side surface SR22A of the housing part R22A (along the direction F) and bring the opposing surface SR22B into contact with the side surface SR22A of the housing part R22A. The direction F is parallel to the Y-axis positive direction. A contact surface S80, with the fold part R22B, of a pressing element 80A that presses a part of the fold part R22B0 is a planar surface. The contact surface S80 of the pressing element 80A contacts a part, in the Z-axis direction, of the fold part R22B0. A load measuring instrument is used for measuring the first pressing load. The moving speed of the pressing element 80A is 10 mm/min.

(1.4.2.5) Rigidity of Fold Part of Housing Part (Overall Pressing)

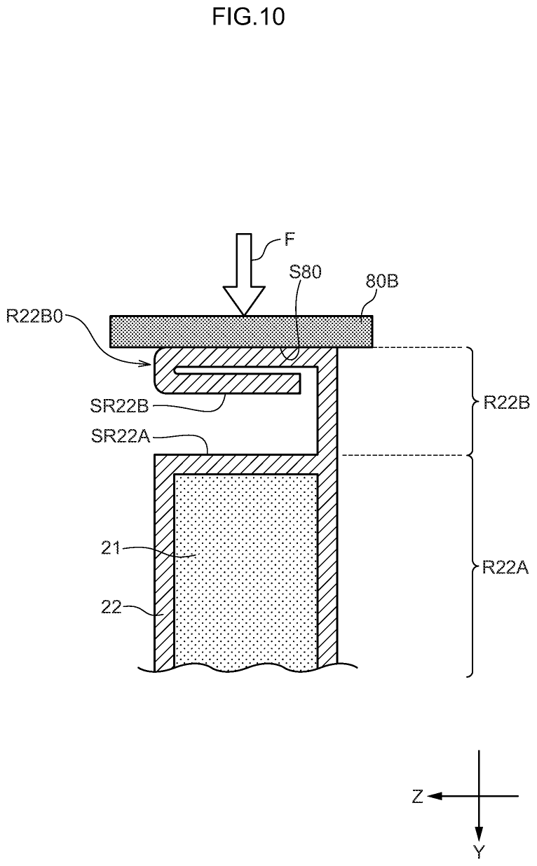

In the first embodiment, a third pressing load is 6.5 MPa or more. As shown in FIG. 10, the third pressing load indicates a load required to press the entire fold part R22B0 toward the side surface SR22A of the housing part R22A (along the direction F) and bring the opposing surface SR22B into contact with the side surface SR22A of the housing part R22A. The contact surface S80, with the fold part R22B, of a pressing element 80B that presses the entire fold part R22B0 is a planar surface. The contact surface S80, with the fold part R22B, of the pressing element 80B contacts the entire fold part R22B0 in the Z-axis direction. A load measuring instrument is used for measuring the third pressing load. The moving speed of the pressing element 80B is 10 mm/min.

(1.4.2.6) Rigidity of Fold Part of Terminal Seal Part (Overall Pressing)

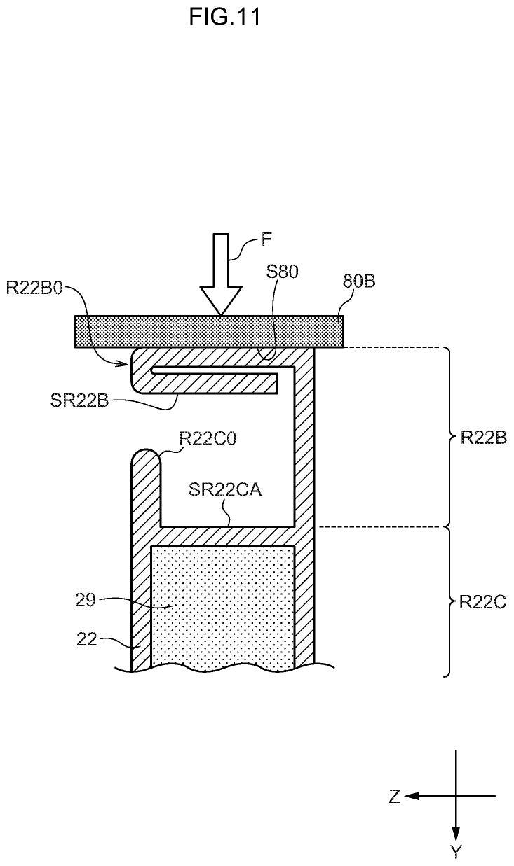

In the first embodiment, a second pressing load is 12.0 MPa or more. As shown in FIG. 11, the second pressing load indicates a load required to press the entire fold part R22B0 toward the side surface SR22CA of the terminal seal part R22C (along the direction F), crush the convex welded part R22CO3 and bring the opposing surface SR22B into contact with the side surface SR22CA of the terminal seal part R22C. The contact surface S80, with the fold part R22B, of the pressing element 80B that presses the entire fold part R22B0 is a planar surface. The contact surface S80, with the fold part R22B, of the pressing element 80B contacts the entire fold part R22B0 in the Z-axis direction. A load measuring instrument is used for measuring the second pressing load. The moving speed of the pressing element 80B is 10 mm/min.

(1.4.2.7) Material

As shown in FIG. 2, the laminate sheet 24 has an outer insulating layer 25, a metal layer 26, and an inner insulating layer 27. The thickness of the laminate sheet 24 may be from 70 μm to 220 μm.

The outer insulating layer 25 functions as a protective layer for the metal layer 26. Examples of the material of the protective layer include polyethylene terephthalate (PET) and nylon. The thickness of the outer insulating layer 25 may be from 20 μm to 60 μm.

The metal layer 26 blocks gas (for example, moisture, air, and the like) from entering and leaving between the outside of the secondary battery 20 and the inside of the secondary battery 20. Examples of the material of the metal layer 26 include aluminum, an aluminum alloy, and stainless steel. The thickness of the metal layer 26 may be from 30 μm to 60 μm.

The inner insulating layer 27 electrically insulates the pair of terminals 29 and the electrode body 21 with respect to the metal layer 26. Examples of the material of the inner insulating layer 27 include olefin-based resins such as polypropylene (PP) and polyethylene (PE). The thickness of the inner insulating layer 27 may be from 40 μm to 100 μm.

(1.5) Electrode Body

The electrode body 21 functions as a power generation element of the secondary battery 20.

The electrode body 21 has plural unit electrode bodies 210 and a pair of current collection tabs (not illustrated). One of the pair of current collection tabs is a positive electrode current collection tab. The positive electrode current collection tab is electrically connected to the positive electrode terminal (one of the pair of terminals 29). The other of the pair of current collection tabs is a negative electrode current collection tab. The negative electrode current collection tab is electrically connected to the negative electrode terminal (the other of the pair of terminals 29). Each of the pair of current collection tabs is electrically connected to the plural unit electrode bodies 210.

The plural unit electrode bodies 210 are rectangular parallelepiped-shaped bodies. The unit electrode body 210 includes a so-called all-solid-state battery (the content of an electrolytic solution as an electrolyte being less than 5% by mass relative to the total amount of the electrolyte) in which an inorganic solid electrolyte is used as the electrolyte.

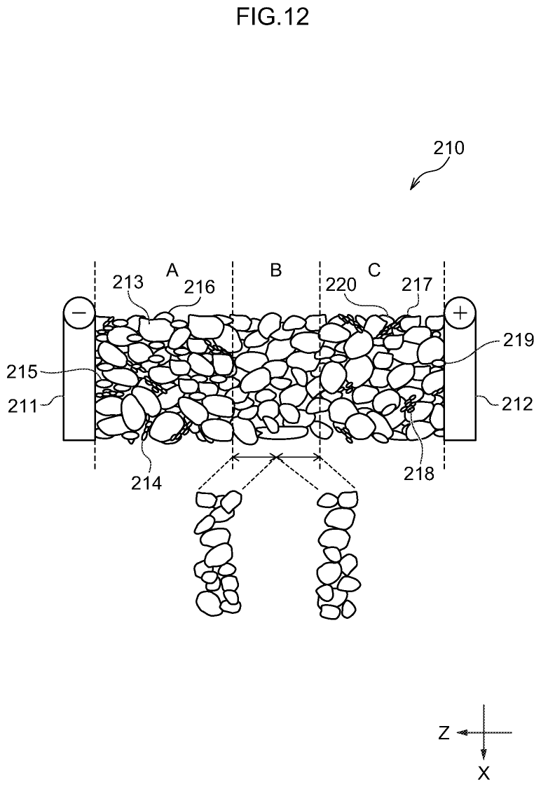

The structure of the unit electrode body 210 may be a structure in which a positive electrode current collector, a positive electrode layer, a solid electrolyte layer, a negative electrode layer, and a negative electrode current collector are layered in this order along the Z-axis direction. For example, the structure may be as shown in FIG. 12. The solid electrolyte layer B in FIG. 12 may have a two-layer structure. FIG. 12 is a schematic cross-sectional view showing an example of the unit electrode body 210. The unit electrode body 210 shown in FIG. 12 includes a negative electrode, a solid electrolyte layer B, and a positive electrode. The negative electrode includes a negative electrode current collector 211 and a negative electrode layer A. The positive electrode includes a positive electrode current collector 212 and a positive electrode layer C. The negative electrode layer A includes a negative electrode active material 213, a conduction auxiliary 214, a binder 215, and a solid electrolyte 216. The positive electrode layer C contains a positive electrode active material 217, a conduction auxiliary 218, a binder 219, and a solid electrolyte 220.

The plural unit electrode bodies 210 may be connected in series, or may be connected in parallel.

The plural unit electrode bodies 210 may be configured such that layered end surfaces (side surfaces) of the layered structure of positive electrode layer/solid electrolyte layer/negative electrode layer are sealed with a resin.

(1.5.1) Solid Electrolyte Layer

The unit electrode body 210 is provided with a solid electrolyte layer. The solid electrolyte layer preferably includes one selected from the group consisting of a sulfide solid electrolyte, an oxide solid electrolyte, and a halide solid electrolyte.

The sulfide solid electrolyte preferably contains sulfur (S) as the main component of an anionic element, and furthermore, for example, preferably contains the element Li and an element A. The element A is at least one selected from the group consisting of P, As, Sb, Si, Ge, Sn, B, Al, Ga, and In. The sulfide solid electrolyte may further contain at least one of O and a halogen element. Examples of the halogen element (X) include F, Cl, Br, and I. The composition of the sulfide solid electrolyte is not particularly limited, and examples thereof include xLi₂S·(100-x)P₂S₅(70≤x≤80) and yLiI·zLiBr·(100-y-z)(xLi₂S·(1-x)P₂S₅) (0.7≤x≤0.8, 0≤y≤30, 0≤z≤30). The sulfide solid electrolyte may have a composition represented by the following general formula (1).

Li₄₋ₓGe₁₋ₓPₓS₄(0<x<1) Formula (1):

In Formula (1), at least a part of the Ge may be substituted with at least one selected from the group consisting of Sb, Si, Sn, B, Al, Ga, In, Ti, Zr, V and Nb. At least a part of the P may be substituted with at least one selected from the group consisting of Sb, Si, Sn, B, Al, Ga, In, Ti, Zr, V and Nb. A part of the Li may be substituted with at least one selected from the group consisting of Na, K, Mg, Ca and Zn. A part of the S may be substituted with halogen. The halogen is at least one of F, Cl, Br, or I.

As the oxide solid electrolyte, oxygen (O) is preferably included as the main component of the anionic element, and for example, Li, an element Q (Q represents at least one of Nb, B, Al, Si, P, Ti, Zr, Mo, W or S), and O may be included. Examples of the oxide solid electrolyte include garnet-type solid electrolytes, perovskite-type solid electrolytes, nasicon-type solid electrolytes, Li—P—O based solid electrolytes, and Li—B—O based solid electrolytes. Examples of a garnet-type solid electrolyte include Li₇La₃Zr₂O₁₂, Li₇₋ₓLa₃(Zr₂₋ₓNbₓ)O₁₂(0≤x≤2), and Li₅La₃Nb₂O₁₂. Examples of a perovskite-type solid electrolyte include (Li, La)TiO₃, (Li, La)NbO₃, and (Li, Sr)(Ta, Zr)O₃. Examples of a nasicon-type solid electrolyte include Li(Al, Ti)(PO₄)₃, and Li(Al, Ga)(PO₄)₃. Examples of an Li—P—O based solid electrolyte include Li₃PO₄, and LIPON (compounds in which a part of the O in Li₃PO₄ is substituted with N), and examples of an Li—B—O based solid electrolyte include Li₃BO₃, and a compound in which a part of the O in Li₃BO₃ is substituted with C.

As the halide solid electrolyte, a solid electrolyte including Li, M and X (M represents at least one of Ti, Al or Y, and X represents F, Cl or Br) is preferred. Specifically, Li_{6-3z}Y_{z}X₆ (X represents Cl or Br, and z satisfies 0<z<2), and Li_{6-(4-x)b}(Ti₁₋ₓAlₓ)_{b}F₆ (0<x<1, 0<b≤1.5) are preferred. Among Li_{6-3z}Y_{z}X₆, in terms of excellent lithium ion conductivity, Li₃YX₆ (X represents Cl or Br) is more preferable, and Li₃YCl₆ yet more preferable. Li_{6-(4-x)b}(Ti₁₋ₓAlₓ)_{b}F₆ (0<x<1, 0<b≤1.5), from the viewpoint of suppressing oxidative decomposition of sulfide solid electrolytes, for example, is preferably contained together with a solid electrolyte such as a sulfide solid electrolyte.

The solid electrolyte layer may have a single-layer structure or a multi-layer structure of 2 or more layers.

The solid electrolyte layer may include a binder, or may not include a binder. Examples of the binder that can be contained in the solid electrolyte layer include halogenated vinyl resins, rubbers, and polyolefin resins. Examples of halogenated vinyl resins include polyvinylidene fluoride (PVdF), and copolymers of polyvinylidene fluoride and hexafluoropropylene (PVdF-HFP). Examples of the polyolefin resin include butadiene rubber (BR), acrylate butadiene rubber (ABR), styrene-butadiene rubber (SBR), acrylonitrile-butadiene rubber (NBR), and butyl rubber (isobutylene-isoprene rubber). Examples of the polyolefin resin include polyethylene and polypropylene. The binder (C) may be a diene-based rubber containing a double bond in its main chain, such as a butadiene-based rubber in which butadiene accounts for 30 mol % or more of the total.

(1.5.2) Positive Electrode Layer

The unit electrode body 210 includes a positive electrode layer. The positive electrode layer contains a positive electrode active material. The positive electrode layer may contain at least one of a solid electrolyte for a positive electrode, a conduction auxiliary, or a binder, as necessary.

The positive electrode active material preferably contains a lithium composite oxide. The lithium composite oxide may contain at least one selected from the group consisting of F, Cl, N, S, Br and I. The lithium composite oxide may have a crystalline configuration belonging to at least one space group selected from the space groups R-3m, Immm, and P63-mmc (also referred to as P63mc, P6/mmc). In the lithium composite oxide, the main arrangement of the transition metal, oxygen, and lithium may have an O2-type structure.

Examples of a lithium composite oxide having a crystal structure belonging to R-3m include a compound represented by LiₓMe_{y}O_{α}X_{β} (Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P; X represents at least one selected from the group consisting of F, Cl, N, S, Br and I; and 0.5≤x≤1.5, 0.5≤y≤1.0, 1≤α≤2, and 0<β≤1 are satisfied).

Examples of a lithium composite oxide having a crystal structure belonging to Immm include a complex oxide represented by Liₓ₁M¹A¹₂ (1.5≤x1≤2.3 is satisfied, M¹ includes at least one selected from the group consisting of Ni, Co, Mn, Cu and Fe, A¹ includes at least oxygen, and the ratio of oxygen in A¹ is 85 atomic % or more) (specifically, Li₂NiO₂), and a complex oxide represented by Liₓ₁M^{1A}₁₋ₓ₂M^{1B}ₓ₂O_{2-y}A²_{y} (0≤x2≤0.5, 0≤y≤0.3, at least one of x2 and y is not 0, M^{1A} represents at least one selected from the group consisting of Ni, Co, Mn, Cu and Fe, M^{1B} represents at least one selected from the group consisting of Al, Mg, Sc, Ti, Cr, V, Zn, Ga, Zr, Mo, Nb, Ta and W, and A² represents at least one selected from the group consisting of F, Cl, Br, S and P).

Examples of a lithium composite oxide having a crystal structure belonging to P63-mmc include complex oxides represented by M1ₓM2_{y}O₂ (M1 represents an alkali metal (preferably at least one of Na or K), M2 represents a transition metal (preferably at least one selected from the group consisting of Mn, Ni, Co and Fe), and x+y satisfies 0<x+y≤2).

Examples of a lithium composite oxide having an 02 type structure include composite oxides represented by Lix[Li_{α}(MnₐCo_{b}M_{c})_{1-α}]O₂ (0.5<x<1.1, 0.1<α<0.33, 0.17<a<0.93, 0.03<b<0.50, 0.04<c<0.33, and M represents at least one selected from the group consisting of Ni, Mg, Ti, Fe, Sn, Zr, Nb, Mo, W and Bi), and specific examples thereof include Li_{0.744}[Li_{0.145}Mn_{0.625}Co_{0.115}Ni_{0.115}]O₂.

The solid electrolyte for a positive electrode preferably includes one selected from the group consisting of sulfide solid electrolytes, oxide solid electrolytes, and halide solid electrolytes. Examples of a sulfide solid electrolyte include the same as those exemplified as the sulfide solid electrolyte included in the solid electrolyte. Examples of an oxide solid electrolyte include the same as those exemplified as the oxide solid electrolyte included in the solid electrolyte. Examples of a halide solid electrolyte include the same as those exemplified as the halide solid electrolyte included in the solid electrolyte.

Examples of the conduction auxiliary include carbon materials, metal materials, and conductive polymer materials. Examples of carbon materials include carbon black (for example, acetylene black, furnace black, and Ketj en black), fibrous carbon (for example, gas phase carbon fibers, carbon nanotubes, and carbon nanofibers), graphite, and carbon fluoride. Examples of metal materials include metal powders (for example, aluminum powder), conductive whiskers (for example, zinc oxide and potassium titanate), and conductive metal oxides (for example, titanium oxide). Examples of conductive polymer materials include polyaniline, polypyrrol, and polythiophene. Only one type of conduction auxiliary may be used alone, or two or more types thereof may be mixed and used.

Examples of the binder include the same binders as those exemplified as the binder included in the solid electrolyte layer.

(1.5.3) Positive Electrode Current Collector

The unit electrode body 210 includes a positive electrode current collector. The positive electrode current collector collects current in the positive electrode layer. The positive electrode current collector is arranged at a position at an opposite side from the solid electrolyte layer with respect to the positive electrode layer.

Examples of the positive electrode current collector include stainless steel, aluminum, copper, nickel, iron, titanium, and carbon. Aluminum alloy foils or aluminum foils are preferred. The aluminum alloy foil and the aluminum foil may be manufactured using a powder. The shape of the positive electrode current collector is, for example, foil-shaped or mesh-shaped.

The positive electrode current collector may have a configuration in which a buffer layer, an elastic layer, or a positive temperature coefficient (PTC) thermistor layer is disposed on a surface thereof.

(1.5.4) Negative Electrode Layer

The unit electrode body 210 includes a negative electrode layer. The negative electrode layer includes a negative electrode active material. The negative electrode layer may include at least one of a solid electrolyte for a negative electrode, a conduction auxiliary, or a binder, as necessary. Examples of a negative electrode active material include Li-based active materials such as metallic lithium, carbon-based active materials such as graphite, oxide-based active materials such as lithium titanate, and Si-based active materials such as Si alone. Examples of the conduction auxiliary, the solid electrolyte for the negative electrode, and the binder used for the negative electrode include the same as those exemplified as the conduction auxiliary, the solid electrolyte contained in the solid electrolyte layer, and the binder (C) included in the positive electrode layer.

(1.5.5) Negative Electrode Current Collector

The unit electrode body 210 includes a negative electrode current collector. The negative electrode current collector collects current in the negative electrode layer. The negative electrode current collector is arranged at a position at an opposite side from the solid electrolyte layer with respect to the negative electrode layer.

Examples of the negative electrode current collector include stainless steel, aluminum, copper, nickel, iron, titanium, and carbon, and copper is preferable. The shape of the negative electrode current collector is, for example, foil-shaped or mesh-shaped.

The negative electrode current collector may have a configuration in which a buffer layer, an elastic layer, or a positive temperature coefficient (PTC) thermistor layer is disposed on a surface thereof.

(1.6) Mechanism

Next, explanation follows regarding the mechanism and effects of the first exemplary embodiment.

Providing plural contact rollers with different contact angles that abut against the edge part 28 of the conveyed outer package 22 enables the edge part 28 of the outer package 22 to be folded in a stepwise manner. This enables spring-back of the folded edge part 28 of the outer package 22 to be suppressed. As a result, the volume density energy of the secondary battery 20 can be improved.

By providing plural contact rollers with different contact angles that abut against the edge part 28 of the conveyed outer package 22, the respective contact rollers and the respective opposition rollers are formed with different thicknesses. Namely, a contact roller and an opposition roller having a steep contact angle can be made thinner than a contact roller and an opposition roller having a moderate contact angle. This enables the thickness of the contact rollers and the opposition rollers to be reduced in a stepwise manner, enabling a gap formed at the edge part 28 of the folded outer package 22 to be reduced. As a result, the volume density energy of the secondary battery 20 can be improved.

Since the furthest downstream contact roller 90 provided downstream in the conveying direction R is a pressing roller made of an elastic material that presses the edge part 28 of the outer package 22 from the outer side toward the furthest downstream opposition roller 96 disposed in the gap of the edge part 28 of the folded outer package 22, the edge part 28 of the outer package 22 is pressed so as to follow the outer shape of the furthest downstream opposition roller 96. This enables the edge part 28 of the outer package 22 to be configured in a target folded posture.

Since the pressing roller is an elastic body, the elastic body is elastically deformed when pressing the edge part 28 of the outer package 22. Accordingly, even in cases in which there is variation in thickness at the edge part 28 of the outer package 22, the thickness variation can be absorbed and the edge part 28 of the outer package 22 can be folded to a target posture. Namely, regardless of the thickness of the edge part 28 of the outer package 22, the edge part 28 of the outer package 22 can be folded to a target posture. Moreover, damage to the outer package 22 can be suppressed.

The opposition roller (for example, the second intermediate opposition roller 160) has an end surface 161A that restricts movement of the outer package 22 in a direction orthogonal to the conveying direction R, as a result of which movement of the outer package 22 in a direction orthogonal to the conveying direction R is restricted. As a result, the edge part 28 of the outer package 22 can be folded at the intended position.

The outer package 22 of the secondary battery 20 is conveyed between plural contact rollers respectively having different contact angles with the edge part 28 of the outer package 22, and opposition rollers that oppose the contact rollers, and the edge part 28 of the outer package 22 is gradually folded, whereby spring-back of the folded edge part 28 of the outer package 22 is suppressed. As a result, the volume density energy of the secondary battery 20 can be improved.

As explained with reference to FIGS. 1 to 5, the manufacturing apparatus 10 forms the fold part R22B0 at one edge part 28 of the outer package 22 of the secondary battery 20. The manufacturing apparatus 10 has a conveying section 5, an upstream roller group Si, an intermediate roller group S2, a downstream roller group S3, and a furthest downstream roller group S4. The manufacturing apparatus 10 passes the edge part 28 of the secondary battery 20 being conveyed by the conveying section 5 through the upstream roller group Si, the intermediate roller group S2, the downstream roller group S3, and the furthest downstream roller group S4. The edge part 28 is folded in stages to form the fold part R22B0.

As a result, the spring-back amount of the fold part R22B0 of the edge part 28 is suppressed. As a result, the manufacturing apparatus 10 can manufacture a secondary battery 20 that has excellent volume density energy.

As described with reference to FIGS. 1 to 5, in the manufacturing apparatus 10, the upstream roller group Si, the intermediate roller group S2, the downstream roller group S3, and the furthest downstream roller group S4 fold the edge part 28 twice in stages, and form the fold part R22B0.

As a result, a secondary battery 20 having the fold part R22B0, which is formed by folding the edge part 28 twice, is obtained. As a result, the manufacturing apparatus 10 can manufacture a secondary battery 20 that has excellent volume density energy and impact resistance.

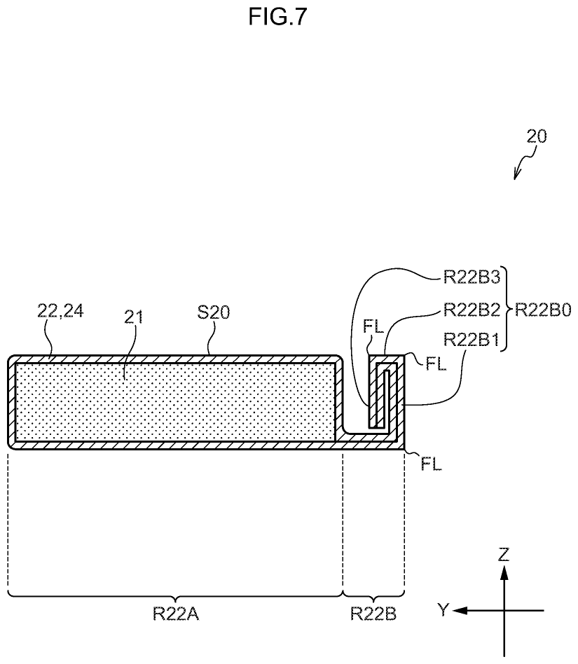

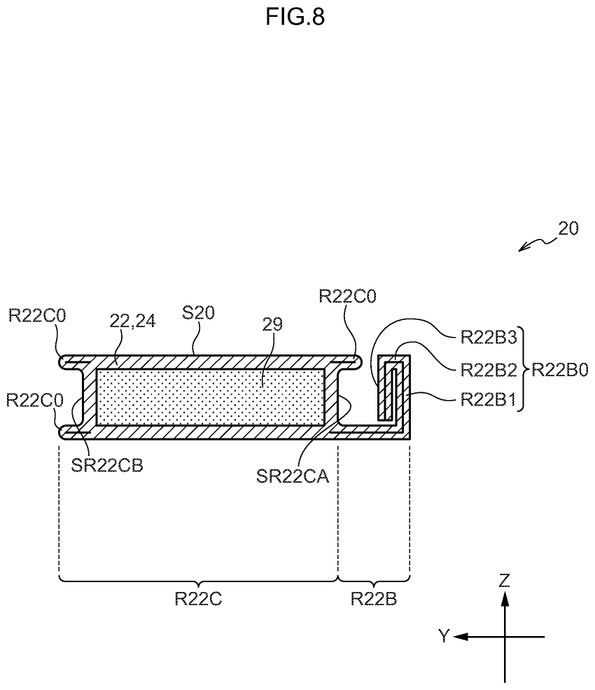

As described with reference to FIGS. 6 to 12, the secondary battery 20 includes the electrode body 21 and the outer package 22. The outer package 22 has a housing part R22A and an edge seal part R22B. The edge seal part R22B has a fold part R22B0. The fold part R22B0 is formed by folding the edge seal part R22B twice.

Therefore, the impact resistance of the secondary battery 20 is superior to the conventional art. As a result, the secondary battery 20 has excellent volume density energy and impact resistance.

As described with reference to FIGS. 6 to 12, the first pressing load of the secondary battery 20 is 6.0 MPa or more.

The fact that the first pressing load is 6.0 MPa or more indicates that the rigidity of the fold part R22B0 in the housing part R22A is excellent. As a result, the secondary battery 20 has excellent impact resistance.

The secondary battery 20 shown in FIGS. 1 to 6 was manufactured using the manufacturing apparatus 10 of the first embodiment. The first pressing load of the secondary battery 20 was 6.05 MPa. The third pressing load of the secondary battery 20 was 6.65 MPa.

Conventional secondary battery was prepared. The first pressing load of a conventional secondary battery was 0.64 MPa. The third pressing load of a conventional secondary battery was 2.16 MPa.

From these results, it was found that the external force required to destroy the electrode body 21 of the secondary battery 20 from the fold part R22B0 in the housing part R22A is about 3 to 10 times the external force required to destroy the electrode bodies of conventional cells. In other words, it was found that the secondary battery 20 has excellent impact resistance.

As described with reference to FIGS. 6 to 12, the secondary battery 20 further includes a pair of terminals 29. The outer package 22 further has a terminal seal part R22C. The terminal seal part R22C has a convex welding part R22C0 at the side surface SR22CA of the terminal seal part R22C.

The convex welding part R22C0 functions as a cushion material with respect to displacement of the fold part R22B0. Therefore, the impact resistance of the secondary battery 20 is superior to a case in which the terminal seal part R22C does not have the convex welded part R22C0. As a result, the secondary battery 20 has excellent volume density energy and impact resistance.

As described with reference to FIGS. 6 to 12, the second pressing load of the secondary battery 20 is 12.0 MPa or more.

The fact that the second pressing load is 12.0 MPa or more indicates that the rigidity of the fold part R22B0 in the terminal seal part R22C is excellent. As a result, the secondary battery 20 has excellent impact resistance.

The secondary battery 20 shown in FIGS. 1 to 6 was manufactured using the manufacturing apparatus 10 of the first embodiment. The second pressing load of the secondary battery 20 was 16.5 MPa. As described above, the third pressing load of the secondary battery 20 was 6.65 MPa.

From these results, it was found that the external force required to destroy the electrode body 21 of the secondary battery 20 from the fold part R22B0 in the terminal seal part R22C is about 2.5 times the external force required to destroy the electrode body 21 of the secondary battery 20 from the fold part R22B0 in the housing part R22A. In other words, it has been found that the secondary battery 20 has excellent impact resistance as compared to a case in which the terminal seal part R22C does not have the convex welded part R22C0.

### (2) Second Embodiment

An apparatus for manufacturing a secondary battery of the second exemplary embodiment is different from the apparatus for manufacturing the secondary battery of the first exemplary embodiment in that the configuration of the contact surfaces of the upstream roller group, the intermediate roller group, and the downstream roller group with the outer package differs.

Explanation follows regarding an apparatus for manufacturing a secondary battery of a second exemplary embodiment. Note that portions that are the same as or equivalent to those described in the first exemplary embodiment are explained using the same terms and reference numerals.

Although explanation follows regarding the second upstream roller pair 330A of the upstream roller group S1, the same applies to other roller pairs.

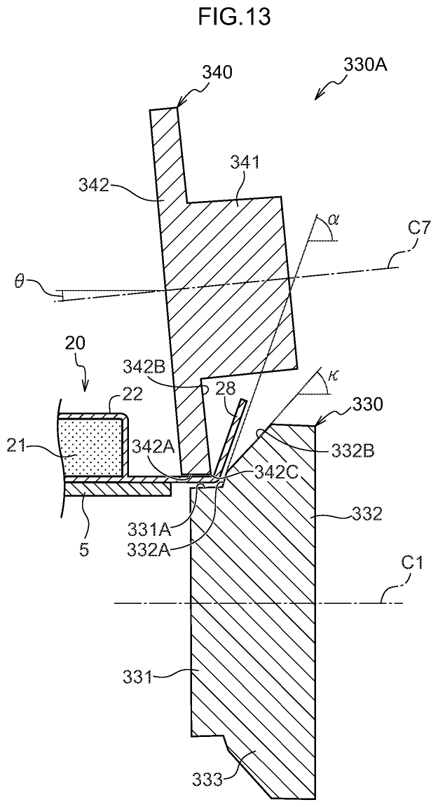

As shown in FIG. 13, the second upstream roller pair 330A includes a second upstream contact roller 330 and a second upstream opposition roller 340 disposed opposing the second upstream contact roller 330.

(2.1) Second Upstream Roller Pair 330A

(2.1.1) Second Upstream Contact Roller 330

The second upstream contact roller 330 is formed of, for example, metal, resin, or the like, and includes a small diameter section 331, a large diameter section 332, and an intermediate section 333.

The small diameter section 331 is disposed on the side of the large diameter section 332 that is closer to the conveying section 5. The large diameter section 332 has a larger outer diameter than the small diameter section 331. The intermediate section 333 is disposed between the large diameter section 332 and the small diameter section 331. The intermediate section 333 is formed so as to expand in diameter from the small diameter section 331 toward the large diameter section 332 so as to connect the outer shape of the large diameter section 332 and the outer shape of the small diameter section 331 together. The outer peripheral surface of the intermediate section 333 is formed by a first inclined surface 332A that is inclined at an angle α (e.g., 60°) relative to the horizontal direction, and a second inclined surface 332B that is inclined at an angle k that is smaller than the angle α relative to the horizontal direction.

The outer peripheral surface 331A of the small diameter section 331 and the first inclined surface 332A of the intermediate section 333 are contact surfaces that abut against the edge part 28 of the outer package 22 conveyed by the conveying section 5. In other words, the edge part 28 of the outer package 22 conveyed by the conveying section 5 abuts against the second upstream contact roller 330 at a base side of a base point portion (near the base point of the folding point) for the folding of the edge part 28.

(2.1.2) Second Upstream Opposition Roller 340

The second upstream opposition roller 340 is configured to be rotatable relative to a rotation axis C7 that is inclined at a predetermined angle β relative to a horizontal direction orthogonal to the conveying direction R. The second upstream opposition roller 340 is formed of, for example, metal, resin, or the like, and includes a small diameter section 341 and a large diameter section 342. The large diameter section 342 is disposed on the side of the small diameter section 341 closer to the conveying section 5. The large diameter section 342 has a larger outer diameter than the small diameter section 341. A corner 342C at a lower end of the large diameter section 342 is disposed so as to abut against the edge part 28. As a result, the edge part 28 of the outer package 22 conveyed by the conveying section 5 is folded at a position where the corner section 342C is in contact with the outer package 22, this position serving as a base point for folding. The outer peripheral surface 342A of the large diameter section 342 and the corner section 342C are contact surfaces that abut against the edge part 28 of the outer package 22 conveyed by the conveying section 5. In other words, the edge part 28 of the outer package 22 conveyed by the conveying section 5 is in contact with the second upstream contact roller 340 at a base side of the base point for folding the edge part 28. Namely, the distal end side of the base portion for the folding of the edge part 28 of the outer package 22 conveyed by the conveying section 5 is not in contact with the second upstream contact roller 330 or the second upstream opposition roller 340.

(2.2) Mechanism

Next, explanation follows regarding the mechanism and effects of the second exemplary embodiment.

The rotation speed differs between the inside in the radial direction and the outside in the radial direction of the roller. Accordingly, in a case in which the edge part 28 of the outer package 22 contacts a side end surface of a roller, the difference between the radially inward and outward frictional forces of the rollers can damage the edge part 28 of the outer package 22.

In the second exemplary embodiment, the edge part 28 of the outer package 22 is in contact with the contact roller and the opposition roller at a base side of the base point for the folding, whereby occurrence of a difference in frictional force at a contact surface with the contact roller and the opposition roller at the edge part 28 of the outer package 22 is suppressed. This enables damage to the edge part 28 of the outer package 22 to be suppressed.

Note that other configurations and mechanisms and effects are substantially the same as those of the first exemplary embodiment, and explanation thereof is omitted.

### (4) Modified Example

The apparatus for manufacturing the secondary battery of the present disclosure has been described above based on the first embodiment and the second embodiment. However, the specific configuration is not limited to these embodiments, and changes in design and the like are permissible so long as they do not depart from the gist of the present disclosure.

In the first exemplary embodiment, an example has been described in which the opposition roller is configured to be rotatable relative to a horizontal rotation axis orthogonal to the conveying direction R. However, the opposition roller may be configured so as to be rotatable relative to a rotation axis inclined at a predetermined angle relative to a horizontal direction orthogonal to the conveying direction R. In this case, the corner portion of the opposition roller can be brought into contact with the edge part 28. This enables the edge part 28 to be folded with stress concentrated at the base point for the folding of the edge part 28.

In the first exemplary embodiment and the second exemplary embodiment, examples have been described in which the contact roller and the opposition roller are driven to rotate by the outer package 22 of the secondary battery 20 that is conveyed by the conveying section 5. However, at least one of the contact roller or the opposition roller may be rotationally driven.

In the first exemplary embodiment and the second exemplary embodiment, examples have been described in which an end surface 161A serving as a restriction part that restricts movement of the outer package 22 in a direction orthogonal to the conveying direction R is provided on an opposition roller. However, this end surface can also be provided on the contact roller.

In the first exemplary embodiment and the second exemplary embodiment, examples in which the contact roller and the opposition roller are rotatably fixed have been described. However, at least one of the contact roller or the opposition roller may be urged toward the edge part 28.

In the first exemplary embodiment and the second exemplary embodiment, examples have been described in which the contact roller and the opposition roller are provided on one side in the width direction of the conveying path along the conveying path of the conveying section 5. However, the contact roller and the opposition roller may be provided on both sides of the conveying path in the width direction along the conveying path of the conveying section 5.

In the first and second embodiments, plural pairs of rollers (i.e., the upstream roller group Si, the intermediate roller group S2, the downstream roller group S3, and the furthest downstream roller group S4) fold the edge part 28 twice in stages to form the fold part R22B0. The present disclosure is not limited thereto, and plural pairs of rollers (i.e., the upstream roller group Si, the intermediate roller group S2, the downstream roller group S3, and the furthest downstream roller group S4) may fold the edge part 28 once in stages to form the fold part, or the edge part 28 may be folded at least three times in stages to form the fold part.

In the first and second embodiments, the first pressing load is 6.0 MPa or more; however, the present disclosure is not limited to this. The first pressing load of the secondary battery of the present disclosure may be less than 6.0 MPa.

In the first and second embodiments, the terminal seal part R22C has the convex welding part R22C0 at the side surface SR22CA of the terminal seal part R22C; however, the present disclosure is not limited to this. In the secondary battery of the present disclosure, the terminal seal part R22C may be without the convex welding part R22C0 at the side surface SR22CA of the terminal seal part R22C.

In the first and second embodiments, the second pressing load is 12.0 MPa or more; however, the present disclosure is not limited to this. The second pressing load of the secondary battery of the present disclosure may be less than 12.0 MPa.

In the first embodiment and the second embodiment, the electrode body 21 has plural unit electrode bodies 210; however, it may have one unit electrode body 210. In the first and second embodiments, the unit electrode body 210 has a solid electrolyte layer; however, a nonaqueous electrolyte solution may be used instead of the solid electrolyte layer. In the first and second embodiments, the secondary battery 20 is a laminate-type lithium secondary battery using a solid electrolyte; however, the battery may be a secondary battery such as a nickel-hydrogen battery.

The apparatus for manufacturing a secondary battery of the present disclosure can be applied to a secondary battery having a laminate outer package.

What is claimed is:

1. An apparatus for manufacturing a secondary battery, the apparatus comprising:
a conveying section configured to convey a laminate-type secondary battery having a laminate outer package;
a plurality of contact rollers provided on a conveying path of the conveying section, the plurality of contact rollers having different contact angles with respect to an edge seal part of the laminate outer package being conveyed; and
opposition rollers respectively disposed in opposition to the contact rollers, which, together with the contact rollers, are configured to fold the edge seal part of the laminate outer package.

2. An apparatus for manufacturing a secondary battery, the apparatus being configured to form a fold part at at least one edge seal part of a laminate outer package of a laminate-type secondary battery, the apparatus comprising:
a conveying section configured to convey the secondary battery in one direction; and
a plurality of pairs of rollers configured to sandwich and fold the edge seal part, wherein:
each of the plurality of pairs of rollers comprises:
a contact roller; and
an opposition roller disposed in opposition to the contact roller, and
the apparatus is configured to pass the edge seal part of the secondary battery being conveyed by the conveying section between the plurality of pairs of rollers, fold the edge seal part in stages, and form the fold part.

3. The apparatus for manufacturing a secondary battery of claim 1, wherein the contact roller, which is provided at a downstream side in a conveying direction, is a pressing roller, which is an elastic body and is configured to press the edge seal part of the laminate outer package from an outer side toward the opposition roller, which is disposed in a gap in a folded edge seal part of the laminate outer package.

4. The apparatus for manufacturing a secondary battery of claim 2, wherein the contact roller, which is provided at a downstream side in a conveying direction, is a pressing roller, which is an elastic body and is configured to press the edge seal part of the laminate outer package from an outer side toward the opposition roller, which is disposed in a gap in a folded edge seal part of the laminate outer package.

5. The apparatus for manufacturing a secondary battery of claim 1, wherein one of the contact roller or the opposition roller comprises a restriction part configured to restrict movement of the laminate outer package in a direction orthogonal to a conveying direction.

6. The apparatus for manufacturing a secondary battery of claim 2, wherein one of the contact roller or the opposition roller comprises a restriction part configured to restrict movement of the laminate outer package in a direction orthogonal to a conveying direction.

7. The apparatus for manufacturing a secondary battery of claim 1, wherein the edge seal part of the laminate outer package abuts against at least one of the contact roller or the opposition roller at a base part side of a base point portion for folding.

8. The apparatus for manufacturing a secondary battery of claim 2, wherein the edge seal part of the laminate outer package abuts against at least one of the contact roller or the opposition roller at a base part side of a base point portion for folding.

9. The apparatus for manufacturing a secondary battery of claim 2, wherein the plurality of pairs of rollers are configured to fold the edge seal part in stages at least twice and form the fold part.

10. A method of manufacturing a secondary battery, the method comprising:
conveying a laminate outer package of a secondary battery between a plurality of contact rollers having different contact angles with an edge seal part of the laminate outer package, and opposition rollers opposing the contact rollers; and
folding the edge seal part of the laminate outer package in stages.

11. A secondary battery, comprising:
an electrode body; and
a laminate outer package covering the electrode body and configured by a laminate sheet, wherein:
the laminate outer package comprises:
a housing part configured to house the electrode body; and
an edge seal part formed by welding together respective end parts of the laminate sheet,
the edge seal part has a fold part formed by folding relative to a main surface of the electrode body, and
the fold part is formed by folding the edge seal part at least twice.

12. The secondary battery of claim 11, wherein:
a first pressing load is 6.0 MPa or higher,
the fold part has an opposing surface facing a side surface of the housing part, and
the first pressing load indicates a load required for pressing a part of the fold part toward the side surface of the housing part and bringing the opposing surface into contact with the side surface of the housing part.

13. The secondary battery of claim 11, further comprising a terminal electrically connected to the electrode body, wherein:
the laminate outer package further comprises a terminal seal part enclosing and sealing the terminal, the terminal extending to an exterior of the laminate outer package,
the fold part has an opposing surface that faces the housing part and a side surface of the terminal seal part,
the terminal seal part has a convex welding part formed by welding an overlapping portion of the laminate sheet at the side surface of the terminal seal part, and
the convex welding part projects toward the opposing surface from the side surface of the terminal seal part.

14. The secondary battery of claim 12, further comprising a terminal electrically connected to the electrode body, wherein:
the laminate outer package further comprises a terminal seal part enclosing and sealing the terminal, the terminal extending to an exterior of the laminate outer package,
the fold part has an opposing surface that faces the housing part and a side surface of the terminal seal part,
the terminal seal part has a convex welding part formed by welding an overlapping portion of the laminate sheet at the side surface of the terminal seal part, and
the convex welding part projects toward the opposing surface from the side surface of the terminal seal part.

15. The secondary battery of claim 13, wherein:
a second pressing load is 12.0 MPa or higher, and
the second pressing load indicates a load required for pressing an entirety of the fold part toward the side surface of the terminal seal part, crushing the convex welding part, and bringing the opposing surface into contact with the side surface of the terminal seal part.

16. The secondary battery of claim 14, wherein:
a second pressing load is 12.0 MPa or higher, and
the second pressing load indicates a load required for pressing an entirety of the fold part toward the side surface of the terminal seal part, crushing the convex welding part, and bringing the opposing surface into contact with the side surface of the terminal seal part.
